(19) United States
(12) Patent Application Publication
(10) Pub. No.: US 2003/0212993 A1
(43) Pub. Date: Nov. 13, 2003

(54) System and method for efficiently managing video files

(76) Inventor: Pere Obrador, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/141,016

(22) Filed: May 7, 2002

(51) Int. Cl. G06F 7/00; G06F 17/30; H04N 7/16; H04H 9/00

(52) U.S. Cl. 725/9; 707/7

(57) ABSTRACT

A system and method for managing a database of video files utilizes user-initiated activities to automatically index video segments of the video files and to automatically extract keyframes for selected video segments. The user-initiated activities include viewing and printing activities. In addition, the system and method allows a user to program a sequence of video segments to be played without having to create a video file containing the video segments.

### FIELD OF THE INVENTION

The invention relates generally to video processing, and more particularly to a system and method for managing video files.

### BACKGROUND OF THE INVENTION

The popularity of video cameras has increased in recent years due to progressive price reductions. Most video cameras use magnetic videotapes to store captured video scenes in analog or digital format. Magnetic videotapes are relatively inexpensive and can store a large quantity of video. A single magnetic videotape may include multiple video scenes. A video scene may be defined as a video sequence having a common subject over a contiguous period of time and space. Therefore, a video scene contains a story or at least contains an independent semantic meaning. A video scene can include one or more video shots. A video shot is a video segment captured continuously over a period of time.

The use of magnetic videotapes does have some disadvantages over other forms of video storage. One of the main disadvantages is that retrieving one or more desired video scenes or shots can be a challenging task. Since captured video scenes are linearly stored on videotape with respect to time, a user may have to search the entire videotape to find a desired video scene or shot. The difficulty in finding a desired video scene or shot is compounded when there are multiple videotapes that may contain the desired video scene or shot.

One solution to more easily retrieve desired video scenes or shots from videotapes is to transfer contents of the videotapes to a video indexing device, such as a personal computer with a video indexing software. If the video scenes are stored in videotapes in an analog format, then the video scenes are first converted into a digital format. In the digital format, video indices can be generated to “mark” the different video scenes and shots. These video indices can be generated automatically using a conventional video indexing algorithm. The video indexing algorithm may detect visual changes between video scenes and shots to identify and index the video scenes and shots. In addition, the video indexing algorithm may automatically select a significant video frame (“keyframe”) from each video scene that best represent that video scene using predefined criteria. Similarly, the video indexing algorithm may also automatically select a keyframe from each video shot that best represent that video shot using the same or different criteria. A single keyframe may represent both a video scene and a video shot of the scene. Alternatively, the video indexing software may allow a user to manually select keyframes for the video scenes and/or shots. The keyframes for the video scenes and shots are subsequently presented to the user so that desired video scenes or shots can be easily retrieved.

The indexed video scenes and shots can be used to create a customized video sequence that includes desired video scenes and/or shots using a video editing software. The customized video sequence, which includes the desired video scenes and/or shots in a specified order, can then be viewed at some later time. The video editing software allows a user to generate the customized video sequence as a digital video file from a database of video files, which may or may not be indexed.

A concern with the conventional video indexing software is that some of the automatically selected keyframes may not be deemed by the user to be the best video frames to represent the corresponding video scenes or shots. Since the selection of keyframes may at times be subjective, the optimal approach is to manually select the keyframes. However, the user will typically have to view the entire video scene or shot to manually select the appropriate keyframe. Consequently, the manual selection of keyframes can be a tedious task when there are more than a few video scenes and/or shots.

Another concern with the conventional video indexing software is that the indexed video scenes and shots are not prioritized. That is, each video scene is indexed and presented in the same manner as the other video scenes. Similarly, each video shot of a video scene is indexed and presented in the same manner as the other video shots of the video scene. Thus, more significant video scenes and/or shots must be manually searched among all the video scenes and/or shots.

With respect to the conventional video editing software, a concern is that the software does not provide an efficient means for users to view customized video sequences. In particular, the video editing software does not allow anyone else to access video files while a user is creating a customized video sequence from the video files. Furthermore, the video editing software does not easily allow a user to modify a customized video sequence to present different video sequence to different audiences. Using the conventional video editing software, each variation of a customized video sequence must be recreated from scratch or generated by editing an existing video sequence.

In view of the above-described concerns, there is a need for a system and method for efficiently managing video files that at least partially addresses these concerns.

### SUMMARY OF THE INVENTION

A system and method for managing a database of video files utilizes user-initiated activities to automatically index video segments of the video files and to automatically extract keyframes for selected video segments. The user-initiated activities include viewing and printing activities. In addition, the system and method allows a user to program a sequence of video segments to be played without having to create a video file containing the video segments. Consequently, a database of video files can be managed in an efficient manner to allow users to easily access desired video segments.

A method of managing video files in accordance with the invention includes the steps of monitoring the viewing activities associated with a video file, identifying defined video segments of the video file that have been viewed, and indexing the defined video segments of the video file based on the viewing activities. The step of indexing the defined video segments may include generating indices of locations in the video file of the defined video segments. In an exemplary embodiment, the step of indexing the defined video segments is executed automatically.

In an embodiment, the step of identifying the defined video segments includes identifying video segments of the video file that have been played using a video player. In this embodiment, the step of monitoring the viewing activities may include monitoring activations and deactivations of a play function of the video player.

In an embodiment, the method further includes a step of updating indexing information with the viewing activities. The indexing information contains viewing statistics of the video segments of the video file, including the viewing statistics of the defined video segments. In this embodiment, the step of indexing the defined video segments may include indexing the defined video segments in a hierarchical browsing structure having at least two levels such that the defined video segments are selectively indexed on the levels of the structure based on the viewing statistics of the defined video segments.

In an embodiment, the method further includes the steps of detecting a selection of a particular video frame from a video file for a predefined function and designating the particular video frame as a representative video frame for at least one video segment of the video file from which the particular video frame was selected. In the exemplary embodiment, the step of designating the particular video frame is executed automatically. Furthermore, the predefined function is the printing of the particular video frame. In this embodiment, the method may further include a step of inserting the particular video frame in a browsing structure, which includes a number of representative video frames that correspond to different video segments of the video file. This inserting step may include replacing an existing representative video frames for at least one video segment of the video file with the particular video frame in the browsing structure. Alternatively, the inserting step may include adding the particular video frame to the browsing structure without replacing the existing representative video frame.

In an embodiment, the method further includes the steps of providing indexing information associated with video segments of video files and generating a video sequence play file of specific video segments of the video files using the indexing information in response to selection of the specific video segments and to selection of the order of the specific video segments. The video sequence play file includes indices of locations in the video files of the specific video segments. The step of providing the indexing information may also include providing a browsing structure that includes representations of the video segments of the video files. The browsing structure may be a hierarchical browsing structure in which the video segments of the video files are positioned in different levels based on a predefined criterion. In this embodiment, the method may further include a step of transmitting the video sequence play file to a local device to play the specific video segments.

A video managing system in accordance with the invention includes a video player configured to play a video file and a hierarchical video indexer configured to monitor viewing activities associated with the video file. The hierarchical video indexer is further configured to identify defined video segments of the video file that have been played using the video player and to index the defined video segments based on the viewing activities. The hierarchical video indexer may be configured to generate indices of locations in the video file of the defined video segments to index the defined video segments.

In an embodiment, the hierarchical video indexer is configured to update indexing information with the viewing activities. The indexing information contains viewing statistics of the video segments of the video file, including the viewing statistics of the defined video segments. In this embodiment, the hierarchical video indexer may be configured to index the defined video segments in a hierarchical browsing structure having at least two levels such that the defined video segments are selectively indexed on the levels of the structure based on the viewing statistics of the defined video segments.

In an embodiment, the video managing system further includes a keyframe extractor configured to detect a selection of a particular video frame for a predefined function and to designate the particular video frame as a representative video frame for at least a video segment of the video file from which the video frame was selected. The predefined function may be the printing of the particular video frame. The keyframe extractor may be further configured to insert the particular video frame in a browsing structure, which includes a number of representative video frames that correspond to different video segments of the video file. The keyframe extractor may be configured to insert the particular video frame by replacing an existing representative video frame for at least one video segment of the video file with the particular video frame in the browsing structure. Alternatively, the keyframe extractor may be configured to add the particular video frame to the browsing structure without replacing the existing representative video frame.

In an embodiment, the video managing system further includes a video organizer configured to generate a video sequence play file of specific video segments of video files using indexing information in response to selection of the specific video segments and to selection of the order of the specific video segments. The video sequence play file includes indices of locations in the video file of the specific video segments. The video organizer may be configured to generate the video sequence play file in response to selection of specific representative video frame on a browsing structure that represent the specific video segments. The browsing structure may be a hierarchical browsing structure in which the video segments of the video files are positioned in different levels based on a predefined criterion.

In an embodiment, the video managing system may further include a remote device and a local device in which the video organizer is included in the remote device. The remote device is configured to establish a communications link such that the video sequence play file can be transmitted from the remote device to the local device.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a video managing system in accordance with an exemplary embodiment of the present invention.

FIGS. 2A-2D illustrate the operation of the hierarchical video indexer of the video managing system to index viewed video segments of an unindexed video file.

FIGS. 3A and 3B are illustrations of browsing structures that can be used to present the video segments of the unindexed video file, after the unindexed video file has been indexed.

FIGS. 4A-4C illustrate the operation of the hierarchical video indexer of the video managing system to index viewed video segments of an indexed video file.

FIGS. 5A and 5B are illustrations of browsing structures that can be used to present the video segments of the video file, after the video file has been indexed.

FIG. 6 is a process flow diagram of a method of indexing a video file in accordance with the exemplary embodiment of the invention.

FIG. 7 is a process flow diagram of a method of extracting keyframes based on printing activities in accordance with the exemplary embodiment of the invention.

FIG. 8 is a process flow diagram of a method of programming a sequence of video segments to be played in accordance with the exemplary embodiment of the invention.

### DETAILED DESCRIPTION

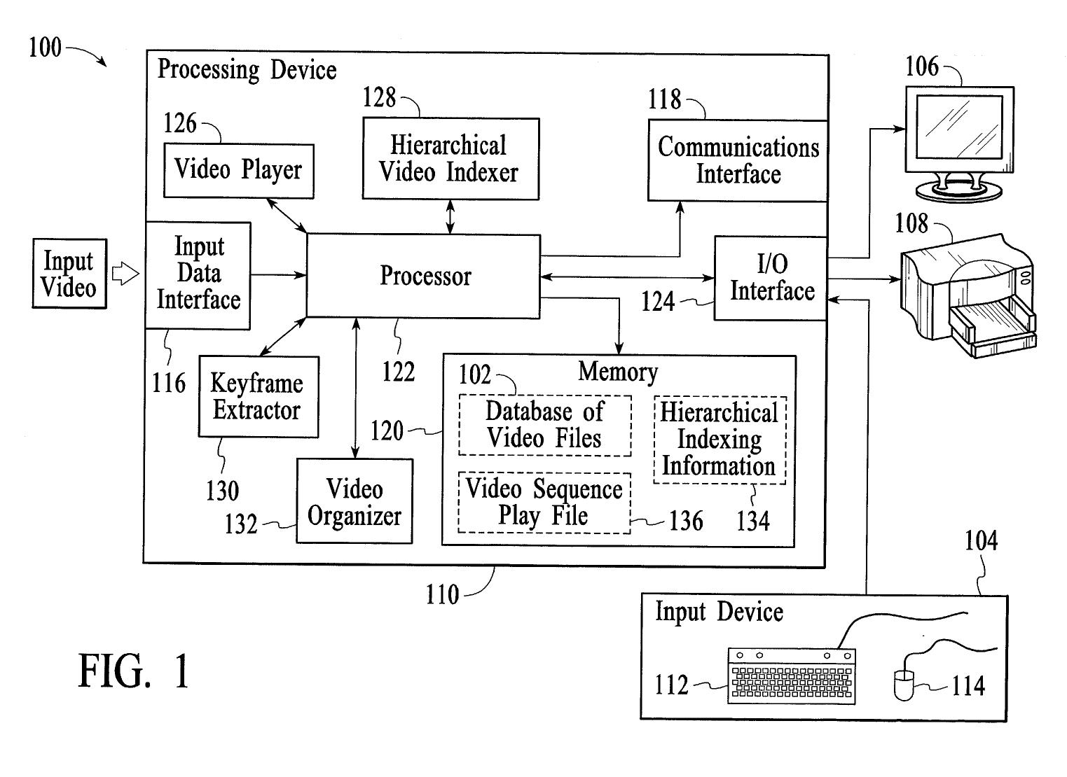

With reference to FIG. 1, a video managing system 100 in accordance with an exemplary embodiment of the invention is shown. The video managing system performs various operations to manage a database 102 of digital video files. A video file is a computer file configured in a particular video format, such as MPEG2, MPEG4, AVI and MOV. Each video file may include one or more video scenes and each video scene may include one or more video shots. Video files, video scenes and video shots are sometimes referred herein collectively as “video segments”. The video managing system operates to automatically index the video files in a hierarchical browsing structure based on the viewing activities of one or more users. Thus, a user can readily access the most “popular” portions of the video files in the database. The video managing system also operates to automatically designate keyframes of video segments, such as video scenes and video shots, using the video frames that are selected by a user for printing. Furthermore, the video managing system operates to allow a user to select a sequence of video segments from the database of video files for playback without having to create a new video file containing the selected video segments. These operations of the system are sometimes referred herein collectively as “managing operations”.

As illustrated in FIG. 1, the video managing system 100 includes an input device 104, a display device 106, a printing device 108 and a processing device 110. Although these devices are shown as separate devices, two or more of these devices may be integrated together. The input device 104 allows a user to input commands into the system. In addition, the input device allows the user to input parameters that are used by the system to manage the database 102 of video files. In the exemplary embodiment, the input device includes a computer keyboard 112 and a cursor pointing mechanism 114, as shown in FIG. 1. However, the input device may be any type of electronic input device, such as buttons, dials, levers and/or switches on the processing device 110.

The display device 106 of the video managing system 100 allows a user to view video files. The display device also allows the user to listen to the accompanying audio contents of the video files. In the exemplary embodiment, the display device is a computer monitor with integrated speakers, such as the illustrated flat panel monitor. However, the display device can be any type of an electronic display device. In an embodiment in which the display device and the processing device 110 are integrated, the display device may include a liquid crystal display and one or more speakers, which are attached to the processing device.

The printing device 108 of the video managing system 100 video frame from the database 102 of video files. The printing device can be any type of printer, such as a laser printer or an inkjet printer. In the exemplary embodiment, the printing device is a photo printer that can print photo-quality images.

The processing device 110 of the video managing system 100 operates to perform the described managing operations so that a user can selectively access the database 102 of video files in an efficient manner. In the exemplary embodiment, the database of video files is stored locally in the processing device. However, the database of video files may be stored remotely in a server/computer (not shown). As shown in FIG. 1, the processing device includes an input data interface 116, a communications interface 118, memory 120, a processor 122 and an input/output (I/O) interface 124. The processing device further includes a video player 126, a hierarchical video indexer 128, a keyframe extractor 130 and a video organizer 132. Although the components 126-132 of the processing device are illustrated and described herein as separate units, these components represent functional blocks, and consequently, may or may not be embodied in the form of physically separate units. Thus, these components may be combined into a single module. Alternatively, one or more of these components may be divided into two or more modules. Therefore, the processing device may include fewer or more components than illustrated and described. In the exemplary embodiment, the components 126-132 are implemented as software. However, these components may be implemented in any combination of hardware, firmware and/or software.

The input data interface, 116, the communications interface 118, the memory 120, the processor 122 and the I/O interface 124 of the processing device 110 are components that are commonly found in personal computers. The input data interface 116 provides a means to receive input videos from an external source (not shown), such as a digital video camera or a portable storage medium. In the exemplary embodiment, the input data interface is configured to receive digitized videos or digital video files. If the input videos are analog videos, the processing device may include an analog-to-digital video converter (not shown) to convert the received analog videos into digital video files. The received video files can then be included in the database 102 of video files. The input data interface may be a USB port, a serial port, a FireWire card or any other interface port that is designed to interface the video managing system 100 to the external source to transfer input videos through a communications link. Alternatively, the input data interface may be a memory slot to receive a portable storage medium, such as a solid-state memory card, which contains one or more input videos as digital video files.

The memory 120 of the processing device 110 is a storage medium to store various data utilized by the video managing system 100. As illustrated in FIG. 1, the memory may store the database 102 of video files, hierarchical indexing information 134 and a video sequence play file 136. The hierarchical indexing information is used by the hierarchical video indexer 128 to index the video files of the database 102. The video sequence play file is used by the video player 126 to play a programmed sequence of video files from the database. The video sequence play file is generated by the video organizer 132. The hierarchical indexing information and the video sequence play file are described in more detail below in reference to the hierarchical video indexer and the video organizer. The memory may also store various parameters that are used by the video managing system, as well as other information. The amount of data that can be stored in the memory is only limited by the storage capacity of the memory. The memory may be a hard disk drive, read-only memory (ROM) or other forms of memory.

The communications interface 118, the processor 122 and the I/O interface 124 of the processing device 110 are well known components, and thus, are described briefly herein. The communications interface 118 allows the video managing system 100 to establish a communications link with a remote device (not shown) through a network, such as LAN, WAN or the Internet. The remote device may be a computer, a server or a handheld device. The communications interface may be a modem, such as a standard dial-up modem or a broadband modem, or a network card. The processor 122 executes signal processing operations in conjunction with the other components 126-132 of the processing device, as described below. The processor may be any type of digital signal processor. The I/O interface 124 provides an interface between the processing device and the input, display and printing devices 104, 106 and 108.

The video player 126 of the processing device 110 operates to play selected video portions from the database 102 of video files. The video player has functions that are commonly found in a standard software video player, such as play, fast forward, fast forward play, fast reverse, fast reverse play, pause, slow play and stop. The video player may be designed to play a video file in one or more of the following video formats: MPEG2, MPEG4, AVI and MOV. As explained in more detail below in reference to the video organizer 132, unlike conventional video players, the video player is configured to automatically play a sequence of video files, video scenes, video shots and/or other video segments when provided with indices of locations of the video segments to be played in the video files of the database and the order in which the video segments are to be played. The indices and the play order are provided to the video player in a computer file, such as an XML file. This computer file is referred herein as a video sequence play file, such as the video sequence play file 136 stored in the memory 120.

The hierarchical video indexer 128 of the processing device 110 operates to automatically index video files, scene, shots and other video segments in a hierarchical browsing structure, which is customized according to the viewing activities of one or more users. The hierarchical video indexer utilizes the hierarchical indexing information 134, which includes data regarding the video files, scenes, shot and/or other video segments that are viewed by one or more users, for the indexing operation. A video segment is considered to be viewed if that segment is played using the video player 126, i.e., the play function of the video player is activated for the entire duration of that video segment. The hierarchical indexing information includes indices of locations of the viewed video segments in the database 102 of video files, as well as statistical data regarding the number of times a particular video segment is viewed. The hierarchical indexing information may also include the name of the user associated with the viewed video segments to distinguish the viewing activities of different users. The hierarchical video indexer can index one or more unindexed video files, i.e., video files that have not been previously indexed. The hierarchical video indexer can also update or modify indexed video files, which have been previously indexed by a conventional automatic video indexer or by the hierarchical video indexer.

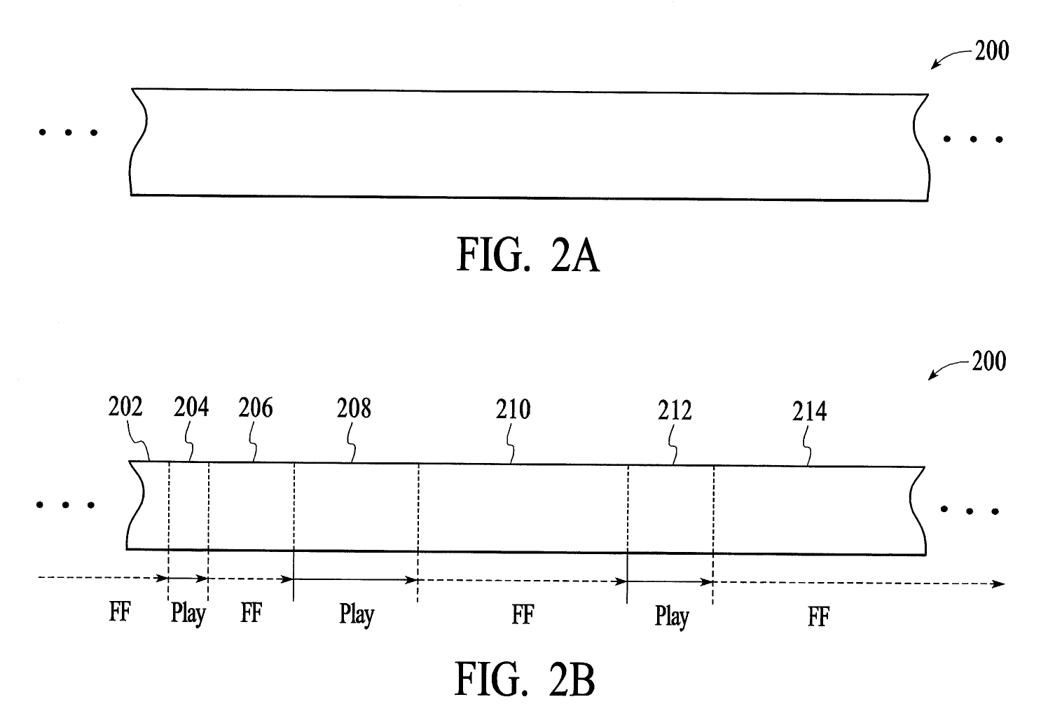

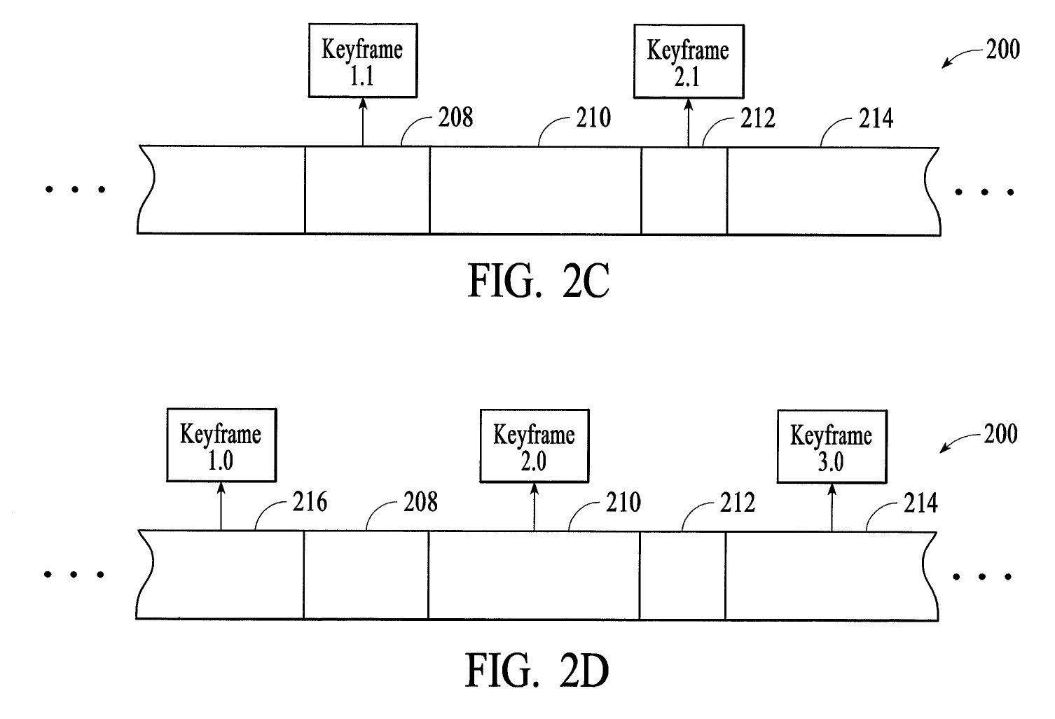

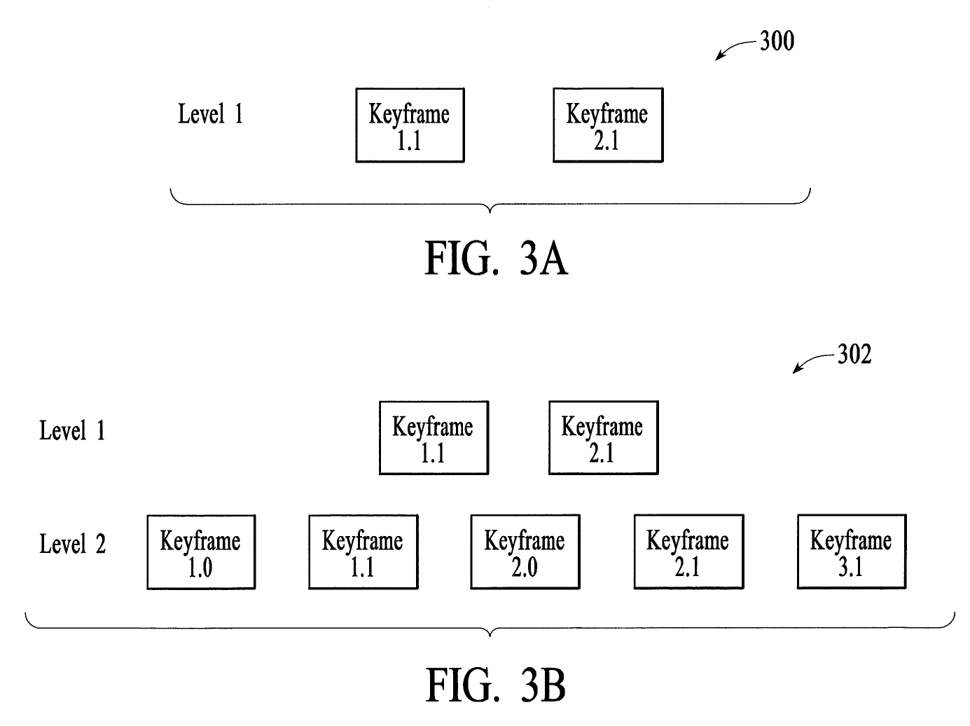

The hierarchical video indexer 128 operates to automatically index an unindexed video file in the manner described below with reference to FIGS. 2A-2D and 3A-3B. In FIGS. 2A-2D, a video file 200 is illustrated as a continuous linear tape. As shown in FIG. 2A, the video file 200 is initially not indexed. That is, no portion of the video file is identified as a video scene, a video shot or other video segment. In operation, when a user accesses the unindexed video file 200 via the video player 126, the hierarchical video indexer monitors the viewing activities of the user to identify viewed portions of the video file and indexes the video file according to the viewed portions. The underlying assumption is that a user will usually view or “play” portions of the video file that are important and will usually skip portions of the video file that are less important. The hierarchical video indexer monitors the viewing activities of the user as defined by repeated activation and deactivation of the play function of the video player to identify the viewed video portions of the video file. However, the hierarchical video indexer is configured to ignore or disregard viewed video portions that are shorter than a predefined duration, e.g., 1 or 2 seconds, so that video portions that are viewed by the user to search for desired video portions of the video file are not considered. As an example, in FIG. 2B, the user has played portions 204, 208 and 212 of the video file 200 and has fast forwarded (FF) portions 202, 206, 210 and 214 of the video file. Thus, the user has viewed the video portions 204, 208 and 212. The played video portion 204 is shorter than the predefined duration. Thus, in this example, the hierarchical video indexer is able to identify the video portions 208 and 212 as viewed video portions. The video portion 204 is not considered to be a viewed video portion since the video portion is shorter than the predefined duration.

The hierarchical video indexer 128 then indexes the video file in a preliminary hierarchical browsing structure using the identified video portions. In the exemplary embodiment, the hierarchical video indexer extracts a keyframe for each viewed video portion to represent that video portion. In the example, keyframes 1.1 and 2.1 are extracted for the video portions 208 and 212, respectively, to represent those video portions, as illustrated in FIG. 2C. The keyframes 1.1 and 2.1 can then be presented to the user on the display device 106 in a preliminary hierarchical browsing structure, such as the single level browsing structure 300 of FIG. 3A. The hierarchical video indexer may also extract a keyframe for each of the remaining video portions of the video file that are defined by the viewed video portions, as illustrated in FIG. 2D. In the example, keyframes 1.0, 2.0 and 3.0 are extracted from the video portions 216, 210 and 214, respectively. The keyframes for the viewed video portions 208 and 212 and the non-viewed video portions 210, 214 and 216 can then be presented to the user on the display device in a preliminary hierarchical browsing structure, such as the dual level browsing structure 302 of FIG. 3B. The dual level browsing structure 302 includes level 1 and level 2. The keyframes 1.1 and 2.1 for the viewed video portions 208 and 212 are positioned on the higher level, i.e., the level 1. The keyframes 1.0, 2.0 and 3.0 for the other video portions are positioned on the lower level, i.e., the level 2. The lower level may also includes the keyframes for the viewed video portions, as illustrated in FIG. 3B. In this manner, the hierarchical video indexer indexes a video file in accordance with the preference of the user as determined by the viewing activities of the user with respect to that video file. As described below, the preliminary hierarchical browsing structure can then be used to generate a hierarchical browsing structure based on the continued viewing activities of the user with respect to that video file.

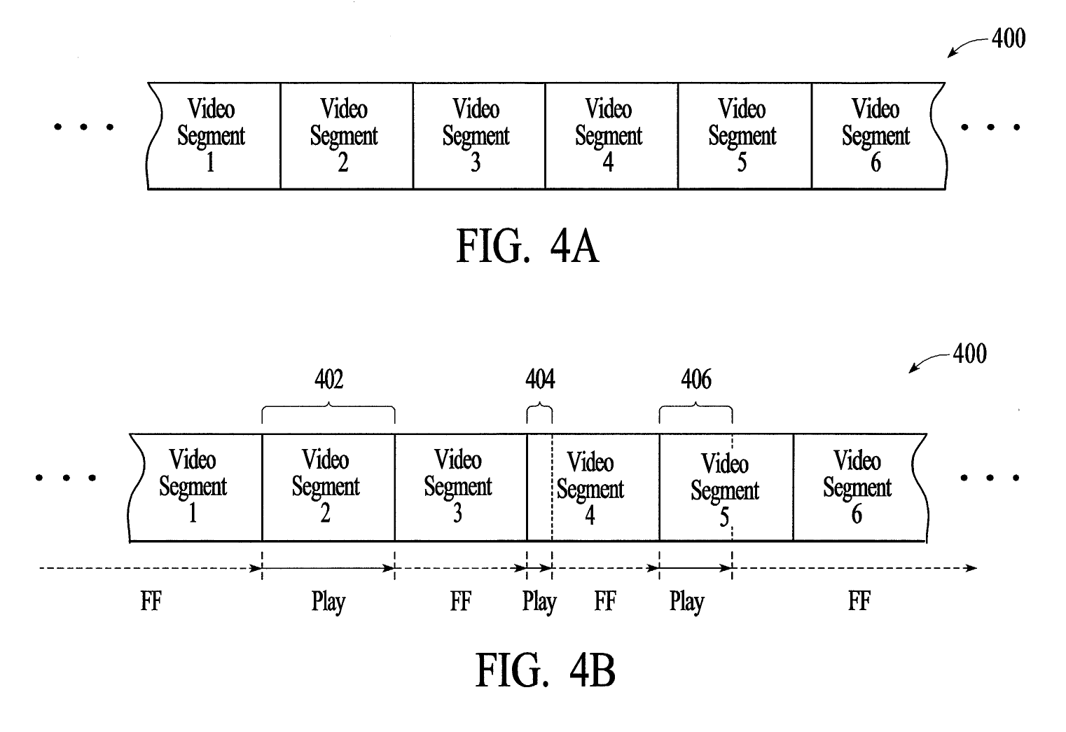

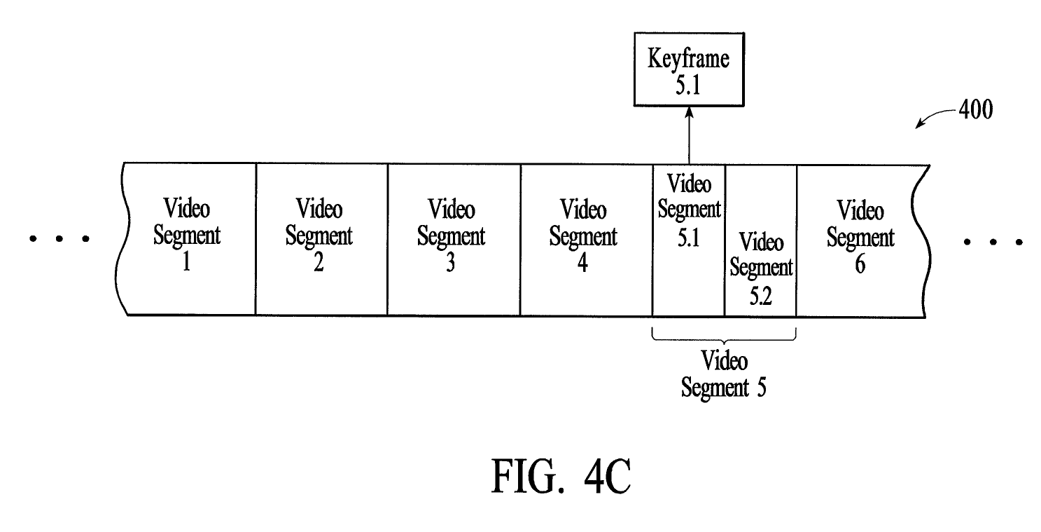

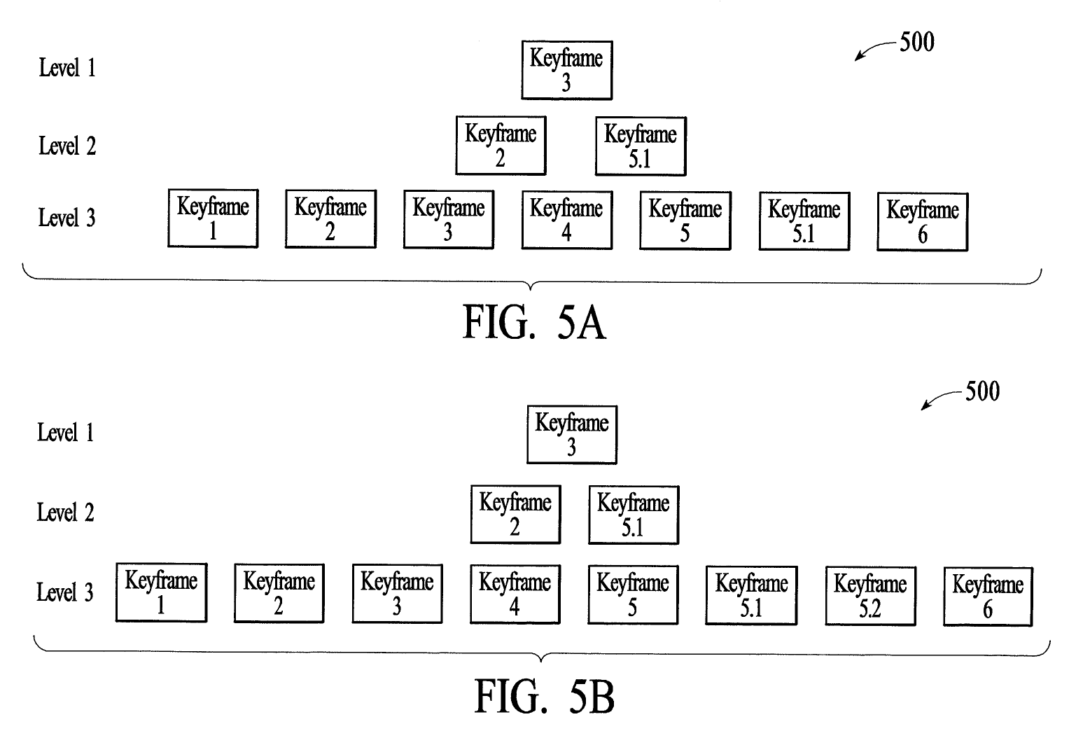

The hierarchical video indexer 128 operates to automatically modify or update an indexed video file in the manner described below with reference to FIGS. 4A-4C and 5A-5B. In FIGS. 4A-4C, a video file 400 is illustrated as a continuous linear tape. As shown in FIG. 4A, the video file is indexed into video segments 1, 2, 3, 4, 5 and 6, which may be video scenes, video shots or other defined video segments. The video file 400 may have been indexed by the hierarchical video indexer using the indexing scheme described above, in which case the video file may be indexed in a preliminary hierarchical browsing structure, such as the dual level browsing structure 302 of FIG. 3B. Alternatively, the video file 400 may have been indexed using other video indexing schemes. As an example, the video file may have been indexed using conventional video shot detection algorithm. In operation, when a user accesses the indexed video file via the video player 126, the hierarchical video indexer monitors the viewing activities of the user to identify viewed portions of the video file and indexes the video file according to the viewing activities. The viewed portions may include entire video segments. The viewed portions may also include portions of the video segments. Similar to the indexing of an unindexed video file, the hierarchical video indexer monitors the viewing activities of the user as defined by repeated activation and deactivation of the play function of the video player to identify the viewed portions of the indexed video file. Again, the hierarchical video indexer is configured to ignore or disregard viewed video portions that are shorter than a predefined duration, e.g., 1 or 2 seconds, so that video portions that are viewed by the user to search for desired video portions of the indexed video file are not considered. As an example, in FIG. 4B, the user has played portions 402, 404 and 406 of the indexed video file 400 and has fast forwarded the remaining portions of the video file, as indicated. The played video portion 402 coincides with the video segment 2. Thus, the entire video segment 2 has been viewed by the user. The played portions 404 and 406 are portions of the video segments 4 and 5, respectively. That is, the user has viewed only portions of the video segment 4 and 5. The played portion 404 is shorter than the predefined duration, and thus, this portion is not considered to be a viewed video portion.

The hierarchical video indexer 128 then identifies any viewed video portion that was not previously indexed. That is, the hierarchical video indexer generates indices for new video segments, which is incorporated into the hierarchical indexing information 136. In the example, the viewed video portion 404 is a video portion that had not been previously indexed. Thus, the viewed video portion 406 is identified by the hierarchical video indexer as a new video segment, which is illustrated in FIG. 4C as the video segment 5.1. Consequently, the indices of location in the video file of the video segment 5.1 are included in the hierarchical indexing information. The hierarchical video indexer also updates the hierarchical indexing information to reflect the current statistical viewing data for the video segments of the video file 400, including the new video segment 5.1. The hierarchical video indexer then utilizes the hierarchical indexing information to update the existing browsing structure. If the existing browsing structure is not a hierarchical browsing structure, then the hierarchical video indexer generate a new hierarchical browsing structure for the video file. However, if the existing browsing structure is a hierarchical browsing structure, the hierarchical video indexer updates the existing hierarchical browsing structure. Based on the statistical viewing data associated with each video segment of a video file, video segments that have been viewed more times are indexed in a higher level of the hierarchical browsing structure than video segments that have been viewed fewer times. The criterion for being indexed at a higher level of the hierarchical browsing structure may be predefined. For example, a video segment of a video file may be elevated to a higher level of the hierarchical browsing structure when the video segment has been viewed twice by the user at the current level of the hierarchical browsing structure.

In the exemplary embodiment, the hierarchical video indexer 128 extracts a keyframe for each new identified video segment of a video file to represent that video segment. Since a new identified video segment is a video portion of an existing video segment, the keyframe for the existing video segment may be replaced with the keyframe of the new identified video segment. If the existing video segment includes two or more new identified video segments, then the existing keyframe may be replaced with two or more keyframes of the new identified video segments.

In the example, as illustrated in FIG. 4C, a keyframe 5.1 is extracted for the new indexed video segment 5.1. The keyframes for the video segments of the video file 400 can then be presented to the user on the display device 106 in a hierarchical browsing structure, such as the hierarchical browsing structure 500 of FIG. 5A. Assuming that the video segments of the video file 400 are video shots of a video scene and that the criterion for elevating a video segment to the next higher level of the hierarchical browsing structure is a single viewing of that video segment, the hierarchical browsing structure 500 may include three levels, as illustrated in FIG. 5A. The highest level of the hierarchical browsing structure, i.e., the level 1, includes the keyframe 3 that represents the keyframe for the entire video scene. The keyframe 3 is also the keyframe for the video segment 3. The intermediate level of the hierarchical browsing structure, i.e., the level 2, includes the keyframes 2 and 5.1, which are the keyframes for the viewed video segments 2 and 5.1. The lowest level of the hierarchical browsing structure, i.e., the level 3, includes the keyframes 1, 2, 3, 4, 5, 5.1 and 6 for the video segments 1, 2, 3, 4, 5, 5.1 and 6 of the video file, respectively. Thus, the video segments of the video file 400 have been indexed so that a user may select more significant video segments, i.e., the video segments 2 and 5.1, in an efficient manner. The hierarchical video indexer 128 may also extract a keyframe for each of the remaining video portions created by the new identified video segments. In the example, the video segment 5.2 is created by the new identified video segment 5.1, as shown in FIG. 4C. Thus, a keyframe 5.2 for the video segment 5.2 of the original video segment 5 is extracted. The keyframe 5.2 for the video segment 5.2 may be inserted in the appropriate level of the hierarchical browsing structure, such as level 3 of the hierarchical browsing structure 500, as illustrated in FIG. 5B. In this manner, the hierarchical video indexer modifies an existing browsing structure of the video file, which may be a hierarchical browsing structure generated according to the past viewing activities of the user, into a hierarchical browsing structure in accordance with the latest viewing activities of the user.

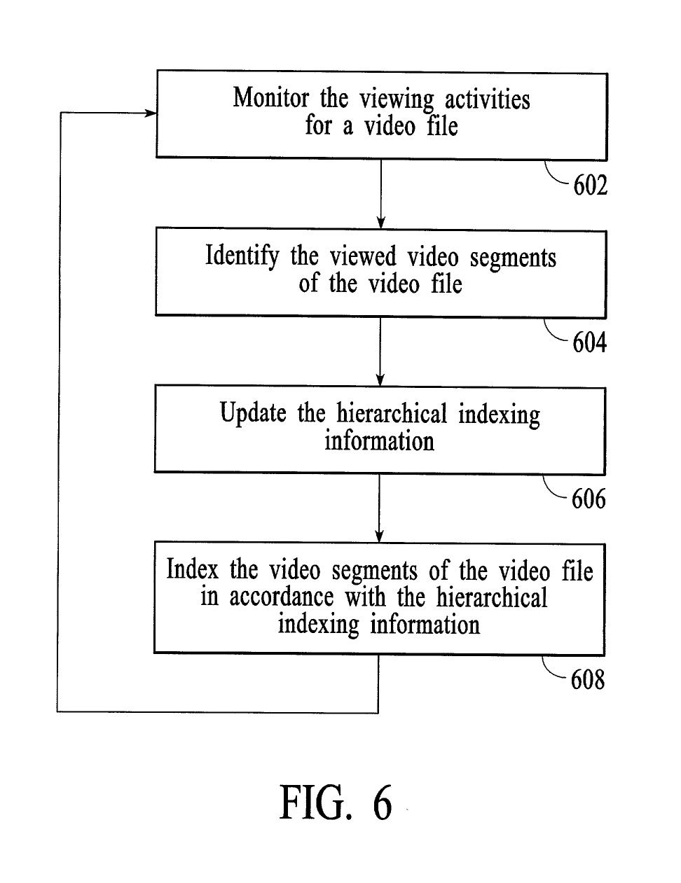

A method of indexing a video file in a hierarchical browsing structure in accordance with the exemplary embodiment of the invention is described with reference to the flow diagram of FIG. 6. At step 602, the viewing activities for a video file are monitored. As an example, the activations and deactivations of the play function of the video player 126 may be detected to monitor the viewing activities. Next, at step 604, the viewed video segments of the video file are identified. The viewed video segments are identified as video segments of the video file that are played by the video player in response to commands by the user. That is, a viewed video segment is the video segment defined by a single activation and a single deactivation of the play function of the video player. However, played video segments that are shorter than a predefined length are not identified as viewed video segments. Next, at step 606, the hierarchical indexing information is updated to reflect indices of new identified video segments of the video file and current viewing statistics of the video segments of the video file. If no hierarchical indexing information exists for the video file, then the hierarchical indexing information is created. At step 608, the video segments of the video file are indexed in accordance with the hierarchical indexing information. If the video file had not been previously indexed, then video segments that are defined by the viewed video segments are indexed in a preliminary hierarchical browsing structure, such as a single level browsing structure or a dual level browsing structure. However, if the video file had been previously indexed, the video segments of the video file are indexed in a hierarchical browsing structure in which video segments that have been viewed more times are indexed at a higher level. The process then proceeds back to step 602, at which the viewing activities for the video file are again monitored. In this fashion, video segments of the video file are indexed according to the viewing activities of the user. Consequently, the user can easily retrieve video segments of the video file that are “more significant” to the user, which have been determined by the repeated viewing of those video segments.

The described indexing method may be used to index multiple video files in a single hierarchical browsing structure in which the highest level may include keyframes that represent the entire video files, while lower levels include keyframes for video segments of the video files based on the viewing activities of the user. Furthermore, the indexing method may be used to index one or more video files according to the viewing activities of individual users. That is, one or more video files may be indexed in different hierarchical browsing structures that correspond to different users. Thus, the hierarchical browsing structure for a particular user can be updated according to the viewing activities of that user, rather than the viewing activities of other users. Although the hierarchical browsing structures correspond to different users, one user may be able to access the hierarchical browsing structure of another user.

Turning back to FIG. 1, the keyframe extractor 130 of the processing device 110 operates to automatically extract keyframes based on video frames that are printed on the printing device 108 of the video managing system 100. The underlying assumption is that if a video frame is significant enough for a user to print, then that video frame is significant enough to be used as a keyframe. Using the printed video frames, the keyframe extractor is able to automatically extract keyframes that are important to the user.

In operation, the keyframe extractor 130 monitors the printing activities of the video managing system 100. When a user selects a video frame from the database 102 of video files file and prints that video frame, the keyframe extractor detects the printing of the video frame. The keyframe extractor then designates the printed video frame as the keyframe for one or more video segments of the video file from which the video frames was selected. As an example, the keyframe extractor may designate the printed video frame for only the video shot from which the video frame was selected. Alternatively, the keyframe extractor may designate the printed video frame for both the video shot and the video scene from which the video frame was selected.

In one configuration, the keyframe extractor 130 then replaces one or more existing keyframes with the printed video frame in a browsing structure, depending on the keyframe designation of the video frame. The browsing structure may be a hierarchical browsing structure, such as the hierarchical browsing structures 500 FIG. 5A. As an example, if the printed video frame is designated as the keyframe for only a video shot, then only the existing keyframe for that video shot is replaced by the printed video frame. However, if the printed video frame is designated as the keyframe for both a video shot and a video scene, then the keyframes for the video shot and scene are replaced by the printed video frame.

In an alternative configuration, the keyframe extractor 130 inserts the printed video frame in the browsing structure as an additional keyframe for one or more video segments, rather than replacing the existing keyframes for the designated video segments. In the exemplary embodiment, the printed video frame is placed next to the existing keyframes for the designated video segments in the browsing structure. As an example, if the printed video frame is designated as the keyframe for only a video shot, then the video frame is placed next to the existing keyframe for that video shot. However, if the printed video frame is designated as the keyframe for both a video shot and a video scene, then the video frame is placed next to the existing keyframe for the video shot and the existing keyframe for the video scene.

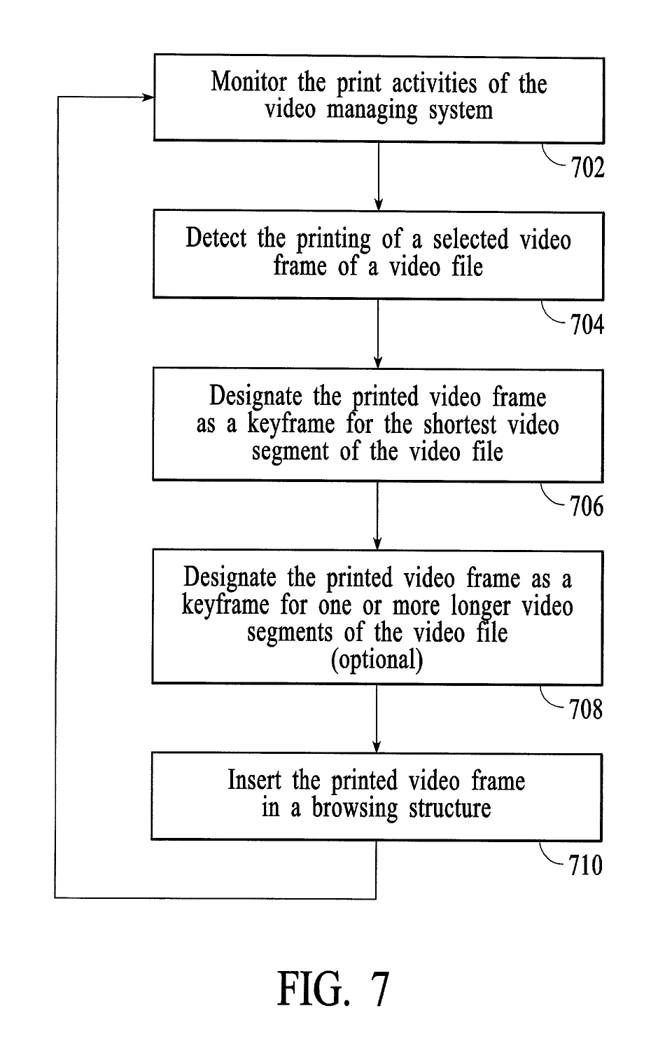

A method of extracting keyframes based on printing activities in according to the exemplary embodiment of the invention is described with reference the process flow diagram of FIG. 7. At step 702, the print activities of the video managing system 100 are monitored. Next, at step 704, the printing of a selected video frame of a video file from the database 102 of video files is detected. At step 706, the printed video frame is designated as a keyframe for the shortest video segment of the video file, e.g., a video shot, from which the printed video frame was selected. At an optional step 708, the printed video frame is also designated as a keyframe for one or more longer video segments of the video file from which the video frame was selected, e.g., a video scene that includes the video shot. Next, at step 710, the printed video frame is inserted in a browsing structure as a keyframe to represent the designated video segments. The browsing structure may be a hierarchical browsing structure, such as the structures 500 of FIG. 5A. The printed video frame may be inserted in the browsing structure by replacing one or more existing keyframes for the designated video segments with the printed video frame. Alternatively, the printed video frame may be inserted in the browsing structure by adding the printed video frame to the browsing structure to represent the designated video segments along with the existing keyframes for the video segments. The process then proceeds back to step 702, at which the printing activities of the system are again monitored to update the keyframes of the browsing structure when the next video frame from the database of video files is selected and printed.

Although the keyframe extractor 130 and the described method for extracting keyframes use printed video frames to replace or add keyframes to a browsing structure, other user selected video frames may also be used. As an example, a video frame that is selected by the user and saved as a digital image for any purpose may be used as a keyframe to replace or add keyframes to a browsing structure.

Turning back to FIG. 1, the video organizer 132 of the processing device 110 operates to allow a user to program a sequence of video segments from the database 102 of video files to subsequently play the sequence of video segments using the video player 126. The programming of the sequence of video segments is achieved by generating a video sequence play file, such as the video sequence play file 136 stored in the memory 120. The video sequence play file includes the indices for selected video segments to be played and the order in which the selected video segments are to be played. The video segments to be included in the video sequence play file may be selected by selecting representations (e.g., keyframes) of the video segments to be played. In the exemplary embodiment, representations of the video segments in the form of keyframes are selected from a browsing structure, which is displayed on the display device 106. The indices for the selected video segments may be extracted from the indexing information, such as the hierarchical indexing information 134 contained in the memory 120. The play order can be selected by interactively identifying the order using a graphic interface displayed on the display device 106. After the video sequence play file is generated, the video sequence play file can be used by any user to play the programmed sequence of video segments using the video player, which plays the sequence of video segments by selectively accessing the database of video files using the information contained in the video sequence play file. In this manner, a sequence of video segments to be played can be programmed as a simple computer file using only the representations of the video segments without having to create an actual video file containing the desired video segments. Consequently, the sequence of video segments to be played can be easily modified by creating a new video sequence play file or modifying the existing video sequence play file.

In an alternative embodiment, the video organizer 132 resides in a remote device (not shown) to allow a user to remotely program the sequence of video segments to be played on the video managing system 100 by remotely generating a video sequence play file. The remote device may be a personal computer, a server or a handheld device that can be connected to the video managing system 100 through a communications network, such as the Internet. In this embodiment, the remote device may include a copy of the indexing information of the video managing system, such as the hierarchical indexing information 134, or can access the indexing information directly from the system through the communications network. A copy of the generated video sequence play file can then be transmitted to the video managing system so that another user can locally play the programmed sequence of video segments on the video managing system using the video sequence play file. One feature of this alternative embodiment is that, while one user is remotely programming a sequence of video segments by generating a video sequence play file using the remote device, another user may access the database 102 of video files in the memory 120, since the actual video files are not being accessed when generating the video sequence play file.

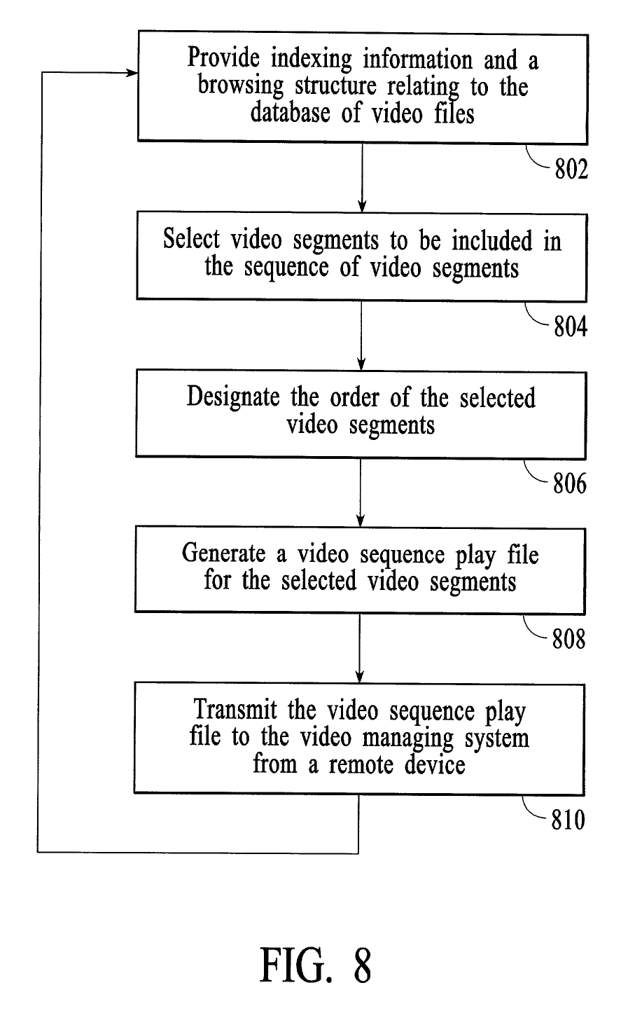

A method of programming a sequence of video segments to be played in accordance with the exemplary embodiment is described with reference to the hierarchical browsing structure 500 of FIG. 5A and the process flow diagram of FIG. 8. At step 802, indexing information relating to the database 102 of video files is provided. The indexing information may be hierarchical indexing information, such as the hierarchical indexing information 134 stored in the memory 120. The indexing information includes at least the indices of locations of video segments in the video files. In the exemplary embodiment, a browsing structure of the indexed video segments of the database of video files is also provided. The browsing structure may be a hierarchical browsing structure generated by the hierarchical video indexer 128, such as the hierarchical browsing structure 500 of FIG. 5A. Next, at step 804, video segments to be included in the sequence of video segments are selected by the user using the browsing structure. The video segments may be selected by selecting the corresponding keyframes of the browsing structure. As an example, using the hierarchical browsing structure 500 of FIG. 5A, the user may select the keyframes 2 and 5.1 to select the corresponding video segments 2 and 5.1 of the video file 400, which are illustrated in FIG. 4C. At step 806, the order of the selected video segments in the sequence of video segments is designated by the user. In the example, the order of the selected video segments may be designated in the following order: the video segment 2 and the video segment 5.1.

Next, at step 808, a video sequence play file is generated for the selected video segments. The video sequence play file includes the indices of locations in the respective video files of the selected video segments and the play order of the selected video segments. If the programming of the sequence of video segments is executed using a remote device, then a copy of the video sequence play file is transmitted to the video managing system 100, through a communications network, at step 810. The video sequence play file can then be used to play the sequence of video segments using the video player 126 of the video managing system. The sequence of video segments is played by selectively accessing the database 102 of video files to retrieve the video segments that are to be played based on the data contained in the video sequence play file.

Although a specific embodiment of the invention has been described and illustrated, the invention is not to be limited to the specific forms or arrangements of parts so described and illustrated. The scope of the invention is to be defined by the claims appended hereto and their equivalents.

What is claimed is:

1. A method of managing video data comprising:
monitoring viewing activities associated with said video data;
identifying defined video segments of said video data that have been viewed; and
indexing said defined video segments of said video data based on said viewing activities.

2. The method of claim 1 wherein said indexing of said defined video segments is executed automatically.

3. The method of claim 1 wherein said identifying of said defined video segments includes identifying video segments of said video data that have been played using a video player.

4. The method of claim 3 wherein said monitoring of said viewing activities includes monitoring activations and deactivations of a play function of said video player.

5. The method of claim 1 wherein said indexing of said defined video segments includes generating indices of locations in said video data of said defined video segments.

6. The method of claim 1 further comprising updating indexing information with said viewing activities, said indexing information containing viewing statistics of said defined video segments and other video segments of said video data.

7. The method of claim 6 wherein said indexing of said defined video segments includes indexing said defined video segment of said video data in a hierarchical browsing structure having at least two levels, said defined video segments being selectively indexed on said at least two levels based on the said viewing statistics of said defined video segments.

8. The method of claim 1 further comprising:
detecting a selection of a particular video frame from said video data for a predefined function; and
designating said particular video frame as a representative video frame for at least one video segment of said video data from which said particular video frame was selected.

9. The method of claim 1 further comprising:
providing indexing information associated with video segments of said video data; and
generating a video sequence play file of specific video segments of said video data using said indexing information in response to selection of said specific video segments and to selection of the order of said specific video segments, said video sequence play file including indices of locations in said video data of said specific video segments.

10. A system for managing video data comprising:
a video player configured to play said video data; and
an indexing unit configured to monitor viewing activities associated with said video data, said indexing unit being further configured to identify defined video segments of said video data that have been played using said video player and to index said defined video segments based on said viewing activities.

11. The system of claim 10 wherein said indexing unit is configured to monitor activations and deactivations of a play function of said video player.

12. The system of claim 10 wherein said indexing unit is configured to generate indices of locations in said video data of said defined video segments.

13. The system of claim 10 wherein said indexing unit is configured to update indexing information with said viewing activities, said indexing information containing viewing statistics of said defined video segments and other video segments of said video data.

14. The system of claim 13 wherein said indexing unit is configured to index said defined video segment of said video data in a hierarchical browsing structure having at least two levels, said defined video segments being indexed on said at least two levels based on said viewing statistics of said defined video segments.

15. The system of claim 10 further comprising a video frame extractor, said video frame extractor being configured to detect a selection of a particular video frame from said video data for a predefined function and to designate said particular video frame as a representative video frame for at least a video segment of said video data from which said particular video frame was selected.

16. The system of claim 10 further comprising a video organizer, said video organizer being configured to generate a video sequence play file of specific video segments of said video data in response to selection of said specific video segments and to selection of the order of said specific video segments, said video sequence play file including indices of locations in said video data of said specific video segments.

17. A method of managing video data comprising:
detecting a selection of a particular video frame from said video data for a predefined function; and
designating said particular video frame as a representative video frame for at least one video segment of said video data from which said particular video frame was selected.

18. The method of claim 17 wherein said designating of said particular video frame is executed automatically.

19. The method of claim 17 wherein said predefined function includes the printing of said particular video frame.

20. The method of claim 17 further comprising inserting said particular video frame in a browsing structure, said browsing structure including a plurality of representative video frames that correspond to different video segments of said video data.

21. The method of claim 20 wherein said inserting of said particular video frame includes replacing an existing representative video frame for said at least one video segment of said video data with said particular video frame in said browsing structure.

22. The method of claim 20 wherein said inserting of said particular video frame includes adding said particular video frame to said browsing structure for said at least one video segment of said video data without replacing an existing representative video frame for said at least one video segment.

23. The method of claim 17 further comprising:
providing indexing information of video segments of said video data; and
generating a video sequence play file of specific video segments of said video data using said indexing information in response to selection of said specific video segments and to selection of the order of said specific video segments, said video sequence play file including indices of locations in said video data of said specific video segments.

24. A system for managing video data comprising:
memory containing said video data; and
a video frame extractor configured to detect a selection of a particular video frame from said video data for a predefined function, said video frame extractor being further configured to designate said particular video frame as a representative video frame for at least one video segment of said video data from which said particular video frame was selected.

25. The system of claim 24 wherein said predefined function includes the printing of said particular video frame.

26. The system of claim 24 wherein said video frame extractor is further configured to insert said particular video frame in a browsing structure, said browsing structure including a plurality of representative video frames that correspond to different video segments of said video data.

27. The system of claim 26 wherein said video frame extractor is configured to replace an existing representative video frame for said at least one video segment of said video data with said particular video frame.

28. The system of claim 26 wherein said video frame extractor is configured to add said particular video frame to said browsing structure for said at least one video segment of said video data without replacing an existing representative video frame for said at least one video segment.

29. The system of claim 24 further comprising a video organizer, said video organizer being configured to generate a video sequence play file of specific video segments of said video data in response to selection of said specific video segments and to selection of the order of said specific video segments, said video sequence play file including indices of locations in said video data of said specific video segments.

30. A method of managing video data comprising:
providing indexing information associated with video segments of said video data; and
generating a video sequence play file of specific video segments of said video data using said indexing information in response to selection of said specific video segments and to selection of the order of said specific video segments, said video sequence play file including indices of locations in said video data of said specific video segments.

31. The method of claim 30 wherein said providing of said indexing information includes providing a browsing structure that includes representations of said video segments of said video data.

32. The method of claim 31 wherein said browsing structure is a hierarchical browsing structure in which said video segments of said video data are positioned in different levels based on a predefined criterion.

33. The method of claim 30 wherein said generating of said video sequence play file is executed on a remote device and wherein said method further comprises transmitting said video sequence play file to a local device to play said specific video segments.

34. The method of claim 30 wherein said video sequence play file does not include said specific video segments.

35. A system for managing video data comprising:
memory containing indexing information of video segments of said video data; and
a video organizer configured to generate a video sequence play file of specific video segments of said video data using said indexing information in response to selection of said specific video segments and selection of the order for said specific video segments, said video sequence play file including specific indices of locations in said video data of said specific video segment.

36. The system of claim 35 wherein said video organizer is configured to generate said video sequence play file in response to selection of specific representative video frames on a browsing structure that represent said specific video segments.

37. The system of claim 36 wherein said browsing structure is a hierarchical browsing structure in which said video segments of said video data are positioned in different levels based on a predefined criterion.

38. The system of claim 35 further comprising a remote device and a local device, said remote device including said video organizer, said local device including said memory, said remote and local devices being configured to establish a communications link such that said video sequence play file can be transmitted from said remote device to said local device.

39. The system of claim 35 wherein said video sequence play file does not include said specific video segments.

40. A program storage device readable by a machine, tangibly embodying a program of instructions executable by said machine to perform a method of managing video data, said method comprising:
monitoring viewing activities associated with said video data;
identifying defined video segments of said video data that have been viewed; and
indexing said defined video segments of said video data based on said viewing activities.

41. A program storage device readable by a machine, tangibly embodying a program of instructions executable by said machine to perform a method of managing video data, said method comprising:
detecting a selection of a particular video frame from said video data for a predefined function; and
designating said particular video frame as a representative video frame for at least one video segment of said video data from which said particular video frame was selected.

42. The program storage device of claim 41 wherein said predefined function includes the printing of said particular video frame.

43. A program storage device readable by a machine, tangibly embodying a program of instructions executable by said machine to perform a method of managing video data, said method comprising:
providing indexing information associated with video segments of said video data; and
generating a video sequence play file of specific video segments of said video data using said indexing information in response to selection of said specific video segments and to selection of the order of said specific video segments, said video sequence play file including indices of locations in said video data of said specific video segments.

44. The program storage device of claim 43 wherein said generating of said video sequence play file is executed on a remote device and wherein said method further comprises transmitting said video sequence play file to a local device to play said specific video segments.
